(19) United States
(12) Patent Application Publication
(10) Pub. No.: US 2007/0280441 A1
(43) Pub. Date: Dec. 6, 2007

(54) Method And System For Using Advertisement To Sponsor International Mobile Phone Calls For Cellular Telephone Networks

(75) Inventors: Jing Liu, Mountain View, CA (US); Xiaolei Qin, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mino Holdings, Inc., Grand Cayman (KY)

(21) Appl. No.: 11/742,373

(22) Filed: Apr. 30, 2007

Related U.S. Application Data
(60) Provisional application No. 60/797,502, filed on May 3, 2006.

(51) Int. Cl. H04M 1/64

(52) U.S. Cl. 379/88.22

(57) ABSTRACT

A method for making telephone calls whereby advertisers sponsor free calling minutes to telephone customers. In addition, the platform is useful for placing targeted advertising. To this end, advertisers are allowed to insert audio, text and video advertising in an active telephone connection, typically at the beginning of a circuit connection, and a statistical method is exploited to accurately identify and target customers with advertisements based on profiles and past calling activities. In addition, a mathematic modeling system provides a guide to a delivery pattern so that advertiser sponsorship benefits the most customers and permits low cost advertisement placement directed to specific customers and telephone systems.

### CROSS-REFERENCES TO RELATED APPLICATIONS

The present application claims benefit under 35 USC 119(e) of U.S. provisional Application No. 60/797,502, filed on May 3, 2006, entitled “Method And System For Using Advertisement To Sponsor International Mobile Phone Calls For Cellular Telephone Networks,” the content of which is incorporated herein by reference in its entirety.

### STATEMENT AS TO RIGHTS TO INVENTIONS MADE UNDER U.S. FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### COPYRIGHT AND TRADEMARK NOTICE

A portion of this application contains computer codes, which are owned by Mino Holdings, Inc. All rights have been reserved under the copyright protection, Mino Holdings, Inc. ©2005. Additionally, the term “MINO” is a trademark of Mino Holdings, Inc. All rights have been reserved with respect to such trademark term.

### BACKGROUND OF THE INVENTION

The present invention relates to communication or telecommunication. More particularly, the present invention provides a technique, including a method and system, for paying the cost of telephone service in a telecommunication network. As merely an example, the present invention is implemented on a cellular phone network. But it would be recognized that the present invention has a much broader range of applicability including local area networks, a combination of wide and local area networks, the Internet, and the like.

Telecommunication techniques have been known for ages. Ancient peoples communicated wirelessly over distances by smoke and sound. American Indians communicated to each other over long distances using smoke signals. Smoke signals were generally used to transfer visual information from one geographical location to be observed at another geographical location. Since smoke signals could only be seen over a limited range of geographical distances, they were eventually replaced by a telegraphy. Wired telegraphy transferred information from one geographical location to another geographical location using pulsed electrical signals in the form of “dots” and “dashes” over transmission lines. An example of commonly used cipher is Morse Code. Telegraphy has evolved to include wireless telegraphy, data communications and telephony, supporting point to point voice. Telegraphy has been replaced by telephony for interactive voice telecommunications.

Other types of communication techniques have also been developed. An example of such communication techniques is the wireless cellular telephone network. The cellular network relies upon a short-wave digital or analog telecommunication signals in which a subscriber has a wireless connection from a mobile telephone to a relatively nearby transmitter. The transmitter's span of intended coverage is called a cell. Cellular telephone service is often available in urban areas and along major highways. As the cellular telephone user moves from one cell or area of coverage to another, the telephone is effectively passed on to the local cell transmitter. A newer service similar to cellular is personal communications services (PCS).

Although highly successful and useful, cellular phone services are often limited and expensive. For example, cellular phone services are often limited to selected geographic regions. Cellular phone services often have country or regional preferences. That is, certain phone services cannot call outside of geographic regions such as the United States of America. Additionally, cellular phone services are often expensive and difficult to change once the user locks into a particular service for a certain time frequency. Current models for telephone service employ direct charges to the caller, either via an invoice, calling card, credit card or associated charge number. These and other limitations of conventional cellular phone services are described throughout the present specification and more particularly below.

### BRIEF SUMMARY OF THE INVENTION

According to the invention, a platform for making telephone calls is provided whereby advertisers sponsor free calling minutes to telephone customers. In addition, the platform is useful for placing targeted advertising. To this end, advertisers are allowed to insert audio, text and video advertising in an active telephone connection, typically at the beginning of a circuit connection, and a statistical method is exploited to accurately identify and target customers with advertisements based on profiles and past calling activities. In addition, a mathematic modeling system provides a guide to a delivery pattern so that advertiser sponsorship benefits the most customers and permits low cost advertisement placement directed to specific customers and telephone systems. The advertisement placement takes particular advantage of telephones that have high-speed data connectivity and a full-motion video display capability. The details of a least cost mathematical modeling system for telephone calling are described in U.S. patent application Ser. No. 11/248,683 filed 11 Oct. 2005, commonly assigned, which is hereby incorporated by reference herein.

The invention is intended to allow customers to make high-quality international long distance calls without direct charge by incorporating a mechanism whereby advertisers placing ads directed to the customer or to the called party are charged for the calls. It is further intended to provide a mechanism whereby advertisers are able to place advertisements to targeted customers based on customers profile and on each call made by a customer.

The invention will be better understood from the following detailed description and accompanying drawings.

### BRIEF DESCRIPTION OF THE DRAWINGS

FIG. 1 is a flow chart illustrating a technique according to the invention.

FIG. 2 is a flow chart illustrating the operation of the invention.

FIG. 3 is a diagram illustrating a multiple layer optimization model have factors used in determining charges for an individual ad placement.

### DETAILED DESCRIPTION OF THE INVENTION

The details of the invention are described herein below. The following naming conventions and definitions are used herein, although this list is not exhaustive.

### Customer: Users who have an active account and use the services of the present system to make phone calls.

### Advertiser: Sponsors, typically pre-registered and prescreened, who are authorized to send advertisements to targeted customers through the present system.

### AdCall: The name assigned to a platform running on a server to provide customers free international long distance calling minutes and to provide access to an advertiser to send advertisement to targeted customers.

### Server: The central system of the supplemental service provider that provides customers of the supplemental service provider management, client downloading, and billing management.

### Client: A software or firmware application running on mobile telephone handsets enabling customer-users to carry out low-cost international long distance calls.

### Website: a web application identified by a URL address that provides at least product information, client downloading and customer management.

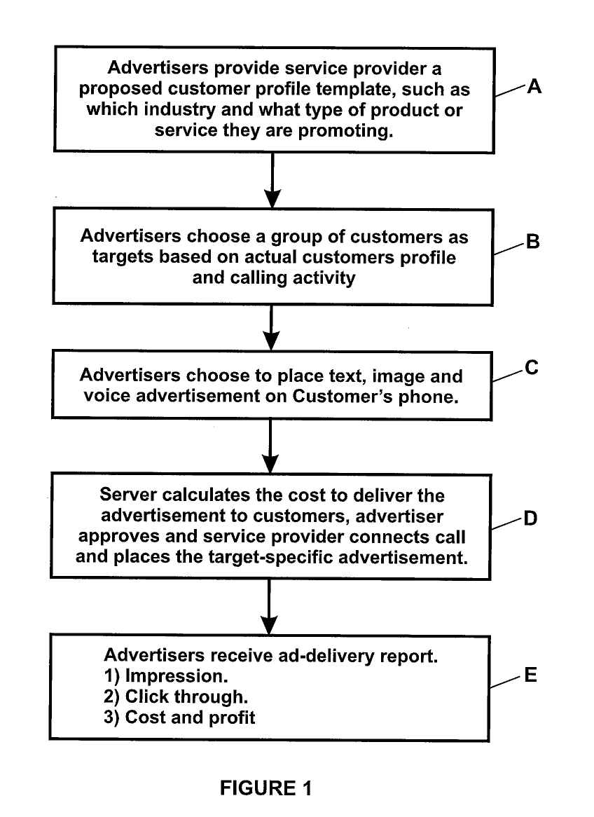

In reference to FIG. 1, a flow chart of operations is shown wherein an advertiser interacts with a database management system embodied as a computer program incorporated into a computer and referred to generally as a server.

To begin, an advertiser supplies the service provider having a customer base with a proposed customer profile template consisting of information as to the industry and type of product or service it is promoting. (Step A). This is used to match up with customers according to actual customer profiles. The actual customer profiles are maintained by the service provider as part of its customer database to protect privacy of its proprietary customers. However, the advertiser is given an opportunity to designate a class of customers matching a particular customer profile as targets for the advertising. (Step B) The advertiser may specify what factors make up a customer profile. The calling activity of a customer may also be factored in, such as frequency and length of calls and areas called or areas from which calls are received.

Once the target customers matching the particular customer profile have been flagged for receiving advertisement by the service provider, the advertiser specifies the type of advertising placement, such as text, image, voice or such other communication medium that is supported by the telephone of the targeted customer. (Step C) For example, a customer profile might include all customers who call China using a Palm Treo-brand multifunction cellphone, which supports e-mail, SMS, motion pictures and music. The advertiser might also choose placement based on the price charged for delivery. The price charged for delivery may be based on the number of identical ads to a group matching a specific customer profile and the tariff charges related to the individual calls. The timing of the ad placement is also to be taken into account. Placement needs to occur when there is the maximum amount of exposure and so as not to unduly inconvenience the customer.

Once decisions have been made about placement, a server computer associated with the service provider is activated to calculate the charge to be assessed the advertiser for the particular advertisement placement. (Step D) With that information, the advertiser can either pre-approve the placement or interactively approve the placement according to its selected criteria, and the service provider can respond to the customer and schedule the placement of the advertisement one or more times during the connection and connect the call for the customer.

After a period, whether short or long, the advertiser receives an ad-delivery report, which may include the number of impressions delivered, the number of click-throughs or purchases made, if applicable, as well as the cost and profit. (Step E) The advertiser can then tailor his delivery scheme and placement content.

The goal of the system according to the invention is to maximize the reachable customer base, maximize the amount of delivered advertisements, minimize delivery cost and optimize profit margin.

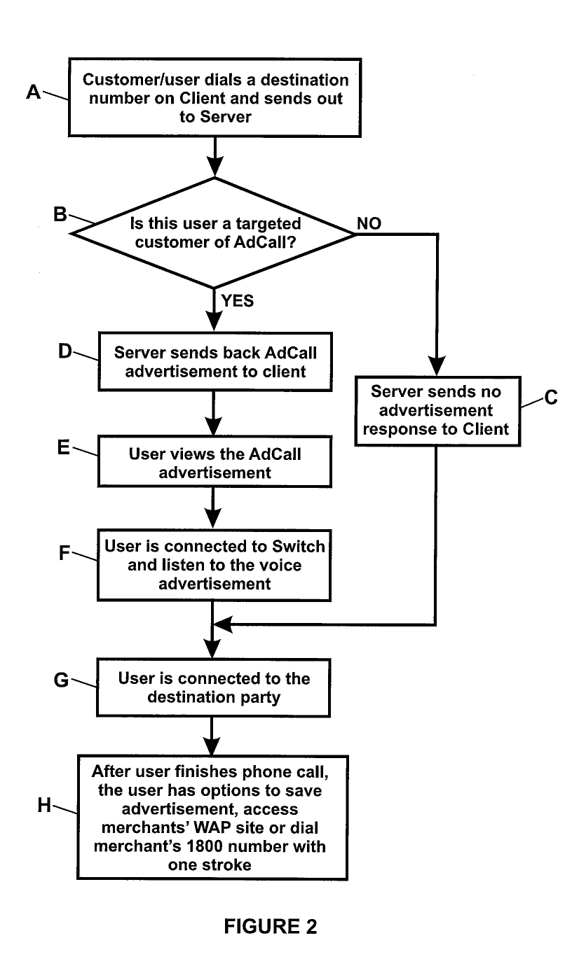

FIG. 2 is a detailed flow chart of the calling procedure using an enhancement according to the invention, herein a software decision making engine termed AdCall. It is to be understood that the AdCall system includes a physical mechanism for receiving input information, a physical interface with a telephone circuit, and subsystems for input and output of data and for input and output of user-associated information, such as display and input keying. Therefore, the system includes but does not herein show a display device, a printer, memory, a computer processing unit, a keyboard, a variety of input ports and of output ports, including ports for telecommunication, and mass storage devices. These components need not be located in a single location. Components could be located at substations or even in a distant country.

In operation, a user keys in or dials or retrieves and specifies a destination number on the client device, such as a cellphone, which in turn sends a communication to a server (Step A). The server tests the communication to see if it is a “targeted customer” of AdCall, namely a customer under contract for the services (Step B). If not, it sends no advertisement response to the client (Step C). This step may involve little or no action by the cell phone or the server, since the intent is to present a conventional scenario of a telephone call for non-AdCall members. If yes, the server sends back an AdCall advertisement to the client (Step D), where the advertisement is displayed for the user's viewing via an appropriately equipped handset, either as text or video (Step E) and the user is connected to the telephone switch, which in turn plays an audio advertisement (Step F). The user is then connected to the destination party (Step G). At the conclusion of the call, the user is given the option to save the advertisement, access the merchant's WAP site or other interactive site, or to call the merchant's contact telephone number, typically a 1-800 WATS line, and preferably any of these by selecting only one key (Step H).

Using the above procedure a user can then place an order directly with the merchant or the agent of the merchant. Typical examples are the ordering of flowers for delivery, including the addition of a personalized message. This is but one of many types of online ordering that can be effected using the advertising subsidized calling method according to the invention.

When the advertising investment of advertisement is constant, a multi-objective optimization model for the distribution of advertising information based on different types of products or services and various customer groups may be used to distribute the advertisement investment of sponsors.

A software package for distributing the advertisement information may be provided to the sponsors via web pages. Administrators of the website could give different weights for each kind of factor and configure the parameters of the distribution model of advertisement information. The advertisement information may be delivered to the customers by a wireless network. The distribution server would collect feedback from customers and perform computations based on the configuration. After the analysis of the feedback data, sponsors and administrators of the website may then extract information on the real-time usage of the advertisement information to determine the profits from advertisement distribution. The process is described as follows:

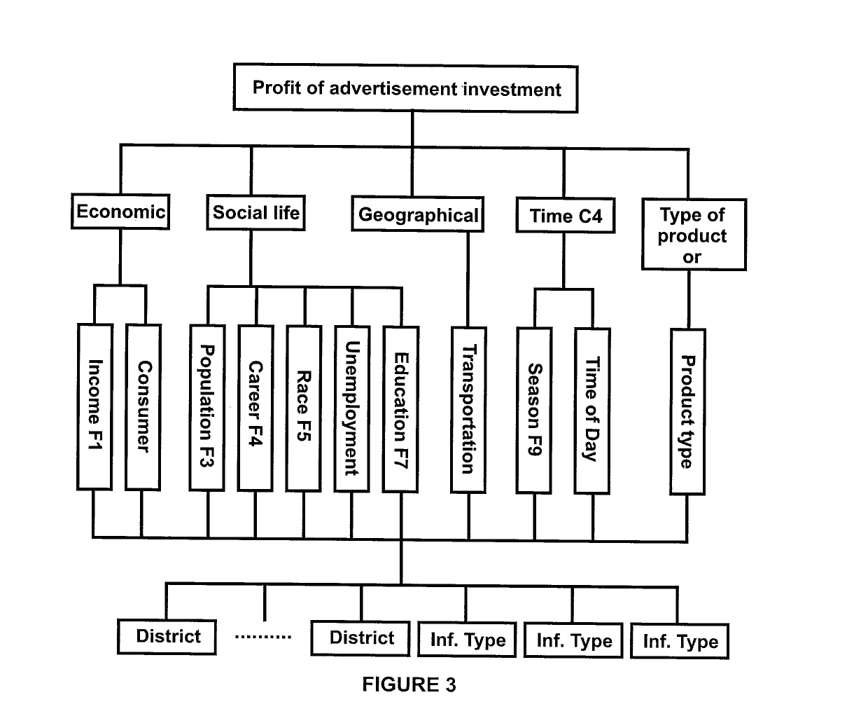

A multi-objective optimization model is built for the distribution of advertisement information, and one semi-structured, multi-layer and multi-objective system is provided to evaluate the distribution of advertisement investment. Reference is made to FIG. 3. The layers used in decision-making are as follows:

### 1. Target Layer: To choose the profit of the advertisement investment as the top layer of the evaluation system.

2. Criteria Layer: To reflect primary factors in the social and economic system which are related closely to the distribution, including economic situation (C1), social life (C2), geographical environment (C3), time (C4), and the type of product or service (C5). Each of them includes one or more qualitative or quantitative factors to reflect the comprehensive situation scientifically and accurately in economic, life, geographic of the targeted districts; the optimization model is built based on these factors to distribute the advertisement investment rationally.
3. Factor layer The following factors, or a significant subset of these factors, should be included in the optimization model:

1) Average income of each family

2) Consumer level

3) Population

4) Career

5) Race

6) Unemployment rate

7) Education

8) Transportation Utility

9) Season

10) Time of day

11) Product (Service) type

The following are goals to be achieved:

### 1, Maximize customer base reached

### 2, Maximize the mount of ads delivered

### 3, Minimize the delivery cost

### 4, Maximize profit

The target function is

### Max.

$${p}_{1} {\sum }_{i = 1}^{N} {Nsub}_{i} + {p}_{2} {\sum }_{i = 1}^{N} ( {\sum }_{j = 1}^{T} {Nads}_{ij} ) + {p}_{3} {\sum }_{i = 1}^{N} {\sum }_{j = 1}^{T} ( - {Nads}_{ij} * {Cads}_{j} ) + {p}_{4} \{ I + {\sum }_{j = 1}^{T} [ ( {\sum }_{i = 1}^{N} {Nads}_{ij} ) * {rate}_{j} ] - {\sum }_{i = 1}^{N} {\sum }_{j = 1}^{T} ( {Nads}_{ij} * {Cads}_{j} ) \}$$

Where the constraints are:

1) Nsubᵢ≦Nuserᵢ;

$$\begin{matrix}1 \leq {Nsub}_{i} \leq {\sum }_{j = 1}^{T} {Nads}_{ij} ( \begin{matrix}or min ( {{Nads}_{i}}_{ij} ) \leq \\ {Nsub}_{i} \leq {\sum }_{j = 1}^{T} {Nads}_{ij}\end{matrix} ) ; & 2 ) \\ {\sum }_{i = 1}^{N} {\sum }_{j = 1}^{T} ( {Nads}_{ij} * {Cads}_{j} ) \leq I ; & 3 )\end{matrix}$$

4) rateⱼ≦1;

Description of Parameters

1) i=1,2 . . . N, N is the number of targeted districts, j=1, 2,3, where 1 denotes text message, 2 audio message, 3 video message.

2) p₁, p₂, p₃, p₄ denotes the weight of each targeted function respectively, and

$${\sum }_{i = 1}^{4} {p}_{i} = 1.$$

3) Nuserᵢ is the sum number of customers in the i^{th} targeted district, Nsubᵢ is the sum number of customers which receive the advertisement information in the i^{st} targeted district.

4) Nadsᵢⱼ is the sum number of the j^{th} type of advertisement information distributed in the i^{th} targeted district.

5) Cadsⱼ is the cost of the j^{th} type of advertisement information.

6) I represents the sum investment of the product or service supplier.

7) rateⱼ denotes the feedback ratio of the customers who receive the j^{th} type of advertisement information.

Weight Calculation

The Analytic Hierarchy Process (AHP) and the Group Eigenvalue Method (GEM are combined to calculate the weight of each of the factors, the detailed steps being as follows:
1. Build a Hierarchical evaluation system (example shown as FIG. 3), which includes the targeted layer, criterion layer, factor layer and decision layer from top to down.
2. Build the m×n evaluation matrix, each cell of which is decided by the m specialists in the group.

X=(xᵢⱼ)_{m×n}

and xᵢⱼ is the value decided by the i^{th} specialist for the j^{th} factor, i=1,2 . . . m; j=1,2 . . . n;
3. Calculate the relative weight of each evaluation factor. According to the GEM algorithm, calculate the weight of each factor under each criterion, then normalize and get the relative weight of each factor under each criterion, the detailed process is as follows:

In the foregoing, the term F=X^{T} X the max eigenvector of F is the optimized decision x*,

$$\begin{matrix}Here k = 0 , {y}_{0} = {( \frac{1}{n} , \frac{1}{n} , … \frac{1}{n} )}^{T} ∈ {E}^{n} , \\ and \\ {y}_{1} = F \cdot {y}_{0} , {z}_{1} = \frac{{y}_{1}}{{‖ {y}_{1} ‖}_{2}} & ( 1 ) \\ Here , \\ k = 1 , 2 , … , \\ and \\ {y}_{k + 1} = F \cdot {z}_{k} , {z}_{k + 1} = \frac{{y}_{k + 1}}{{‖ {y}_{k + 1} ‖}_{2}} & ( 2 )\end{matrix}$$

(3) Here Δzₖ=|zₖ₊₁−zₖ|, judge |Δzₖ|<ε is true or false, if true, then zₖ₊₁ is the needed x*, else go to last step to continue calculation.
4. Combine the weight of each factor to the overall factor from top to down.

The combination of these two algorithm makes it easier to realize the multi-objective decision.

The heuristic algorithm, such as GA (Genetic algorithm) or SA (Simulated Algorithm), is used to calculate the weight factors p₁, p₂, p₃, p₄.

The invention has been explained with reference to specific embodiments. Other embodiments will be evident to those of ordinary skill in the art. It is therefore not intended that this invention be limited, except as indicated by the appended claims.

What is claimed is:

1. A method for making telephone calls allowing free sponsored calling to telephone customers in a telecommunication system comprising:
providing through said telecommunication system a device identity to a telephone client device that identifies said telephone client device as a sponsored device;
in response to a request for a telephone connection, determining through said telecommunication system whether said request is from the sponsored device; and thereafter,
carrying out a telephone call connection in association with sending at least one advertisement to said sponsored device.

2. The method of claim 1 wherein said advertisement is an audio message.

3. The method of claim 1 wherein said advertisement is a text message.

4. The method of claim 1 wherein said advertisement is a video message

5. The method of claim 1 further including:
offering through said telecommunication system an option to respond to said advertisement.

6. The method of claim 5 wherein said advertisement is an audio message.

7. The method of claim 5 wherein said advertisement is a text message.

8. The method of claim 5 wherein said advertisement is a video message.

9. The method of claim 5 wherein said option is to save the advertisement.

10. The method of claim 5 wherein said option is to contact a merchant associated with said advertisement.

11. The method of claim 1 further comprising:
making use of the telecommunication system by:
extracting information from said telephone system; and
building from said information and other available data a multiple-layer optimization model for distribution of advertising, wherein said layers are
1. a target layer, said target layer operative to choose profit of advertisement investment as the top layer;
2. a criteria layer, said criteria layer being operative to reflect primary factors in a social and economic system which are related closely to distribution, including economic situation, social life, geographical environment, time, and type of product or service; and
3. a factor layer, said factor layer including criteria based on customer characteristics.

12. The method according to claim 11 wherein said customer characteristics are selected from the group:
1) Average income of each family
2) Consumer level
3) Population
4) Career
5) Race
6) Unemployment rate
7) Education
8) Transportation Utility
9) Season
10) Time of day.

13. The method of claim 11 wherein said factor layer further includes product type and service type.

14. The method of claim 11 wherein a specific target function is:
Max.
$${p}_{1} {\sum }_{i = 1}^{N} {Nsub}_{i} + {p}_{2} {\sum }_{i = 1}^{N} ( {\sum }_{j = 1}^{T} {Nads}_{ij} ) + {p}_{3} {\sum }_{i = 1}^{N} {\sum }_{j = 1}^{T} ( - {Nads}_{ij} * {Cads}_{j} ) + {p}_{4} \{ I + {\sum }_{j = 1}^{T} [ ( {\sum }_{i = 1}^{N} {Nads}_{ij} ) * {rate}_{j} ] - {\sum }_{i = 1}^{N} {\sum }_{j = 1}^{T} ( {Nads}_{ij} * {Cads}_{j} ) \}$$
Where the constraints are:
5) Nsubᵢ≦Nuserᵢ;
$$\begin{matrix}1 \leq {Nsub}_{i} \leq {\sum }_{j = 1}^{T} {Nads}_{ij} ( \begin{matrix}or min ( {{Nads}_{i}}_{ij} ) \leq \\ {Nsub}_{i} \leq {\sum }_{j = 1}^{T} {Nads}_{ij}\end{matrix} ) ; & 6 ) \\ {\sum }_{i = 1}^{N} {\sum }_{j = 1}^{T} ( {Nads}_{ij} * {Cads}_{j} ) \leq I ; & 7 )\end{matrix}$$
and parameters are
8) i=1,2 . . . N, N is the number of targeted districts, j=1, 2,3, where 1 denotes text message, 2 audio message, 3 video message.
9) p₁, p₂, p₃, p₄ denotes the weight of each targeted function respectively, and
$${\sum }_{i = 1}^{4} {p}_{i} = 1.$$
10) Nuserᵢ is the sum number of customers in the i^{th} targeted district, Nsubᵢ is the sum number of customers which receive the advertisement information in the i^{st} targeted district.
11) Nadsᵢⱼ is the sum number of the j^{th} type of advertisement information distributed in the i^{th} targeted district.
12) Cadsⱼ is the cost of the j^{th} type of advertisement information.
13) I represents the sum investment of the product or service supplier.
and
rateⱼ denotes the feedback ratio of the customers who receive the j^{th} type of advertisement information.

15. A system for making telephone calls allowing free sponsored calling to telephone customers in a telecommunication system comprising:
a device identity provided through said telecommunication system to a telephone client device that identifies said telephone client device as a sponsored device;
a subsystem in said telecommunication system to determine through said telecommunication system in response to a request for a telephone connection whether said request is from the sponsored device; and
a subsystem for carrying out a telephone call connection in association with sending at least one advertisement to said sponsored device.
